(19) United States
(12) Patent Application Publication
(10) Pub. No.: US 2011/0097698 A1
(43) Pub. Date: Apr. 28, 2011

(54) SYSTEM AND METHOD FOR INTERACTIVE LEARNING

(76) Inventor: Charles A. Henderson, Hattiesburg, MS (US)

(21) Appl. No.: 12/913,605

(22) Filed: Oct. 27, 2010

Related U.S. Application Data
(60) Provisional application No. 61/255,375, filed on Oct. 27, 2009.

(51) Int. Cl. G09B 7/00

(52) U.S. Cl. 434/362

(57) ABSTRACT

A system and method for interactive learning is provided. More specifically, a system and method for interactive learning that allows a student or remote user to learn a substantial body of information without, or as a compliment to, formal instruction, classes or courses is disclosed. The system and method include at least on comprehensive presentation that has a network of continual testing throughout the presentation. The system and method also include a web access module for an interactive website and an educational interactive applications generator module configured to present a plurality of web based interactive educational applications.

### RELATED APPLICATIONS

This application claims the benefit of U.S. Provisional Application Ser. No. 61/255,375 filed Oct. 27, 2009 under 35 U.S.C. §119 (hereby specifically incorporated herein by reference in its entirety)

### FIELD

The present invention is related to a system and method for interactive learning that allows students to learn a substantial body of information without, or as a compliment to, formal instruction, classes or courses.

### BRIEF SUMMARY

The invention is a system and method for interactive learning. The system and method allows a particular body of information to be presented to a student with consistent, periodic, multimedia feedback. The system and method for interactive learning takes a predetermined amount of factual information compiled into a comprehensive presentation and teaches it to a student in a cost effective manner without formal instruction, classes or courses. The system and method allows each individual to learn the information on his or her own time and by his or her own effort. The comprehensive presentation may be that which is required to be learned by an individual before starting a particular course, school, assignment, mission or job. The system and method may be used by individuals who plan to participate in an activity or a job such as students, military personnel and new or transferred employees and who need to learn a predetermined about of factual material before starting such activity or job. The system and method may also be used by individuals who need to learn and who wish to retain one or more comprehensive presentations over the course of a certain time period such as a semester and/or year. For example, the system could be utilized to compliment a particular meeting, seminar, or course in which an individual was participating. The predetermined amount of factual material is compiled into a comprehensive presentation compiled in any format such as a lecture series, book, audio recording, video or internet presentation. Regardless of the format, throughout the comprehensive presentation, quizzes and chapter examinations are preferably presented which are complete with answers and explanations. Quizzes and chapter examinations ensure the material is learned as a student progresses through the comprehensive material which continually introduces new information. Upon completion of the comprehensive presentation including the completion of all quizzes and chapter examinations, the student accesses a website to take the final comprehensive examination. Upon completion of the final examination, the examination is graded and categorized allowing a student to know how he or she did in specific categories of the presented material. Student may also access and participate in a plurality of web based educational applications which provide continual testing, reinforcement and teaching. The plurality of web based educational applications may include random follow-up examinations, crossword puzzles, flashcards and interactive posters.

### BRIEF DESCRIPTION OF THE DRAWINGS

The present disclosure will be better understood by reference to the following detailed description when considered in conjunction with the accompanying drawings wherein:

FIG. 1 is a block diagram of the system and method of interactive learning.

FIG. 2 is a flow chart depicting the system and method of interactive learning.

FIG. 3 is a flow chart depicting the system and method of interactive learning.

FIG. 4 is a flow chart depicting the system and method of interactive learning.

FIG. 5 is a flow chart depicting the system and method of interactive learning.

FIG. 6 is a flow chart depicting the system and method of interactive learning.

### DETAILED DESCRIPTION

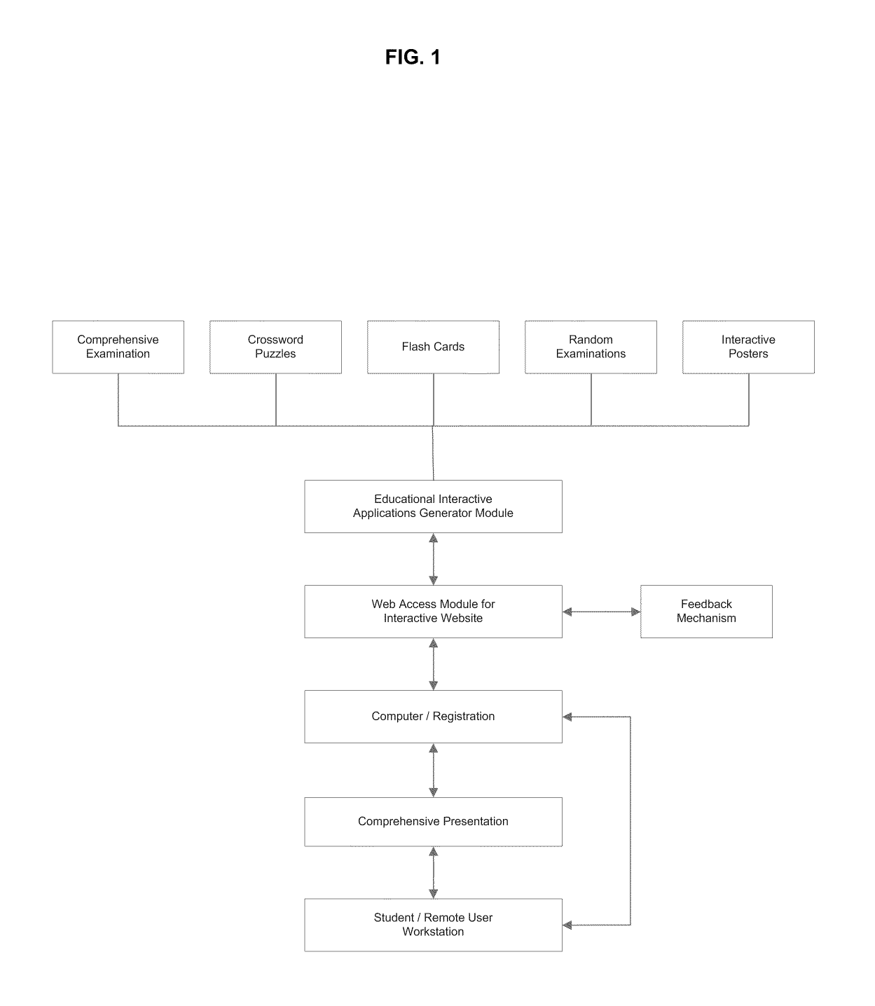

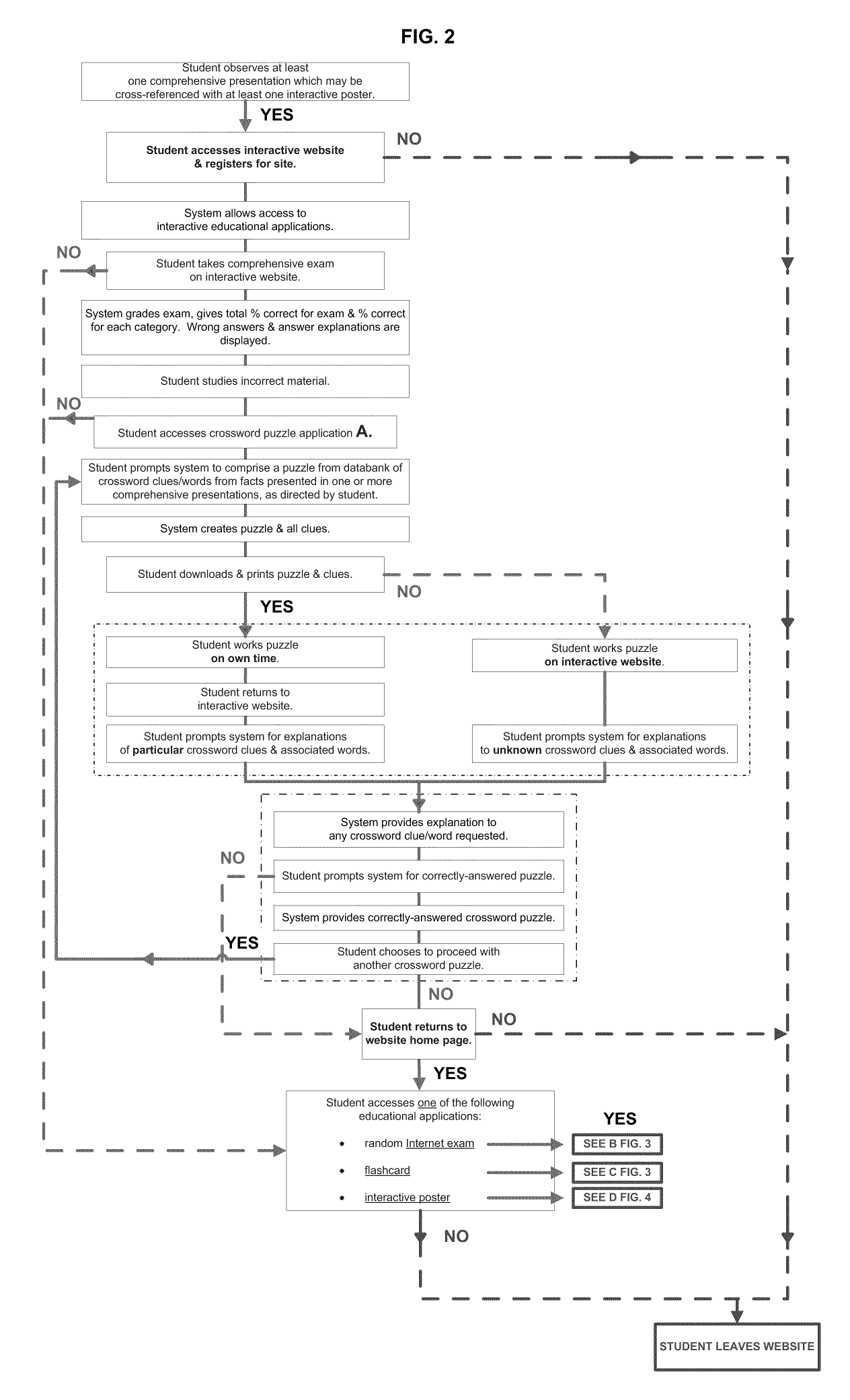

Referring to FIGS. 1 and 2, the system and method for interactive learning includes a student or remote user which observes at least one comprehensive presentation comprising a substantial body of information. A comprehensive presentation is a predetermined amount of factual information. Such at least one comprehensive presentation may present the material in a plurality of formats including but not limited to a lecture series, book, video tape, audio recording, or via a presentation via the internet. In one embodiment, the information presented in comprehensive presentation is presented in a graduated fashion from a basic to an advanced level of knowledge. A network of continual testing is used throughout the comprehensive presentation to teach the student the particular body of information, without the aid of an instructor. The comprehensive presentation may include shaded boxes dispersed throughout each chapter. Each box may include a memory aid such as a mnemonic, acronym, or helpful hint. The comprehensive presentation may include quizzes at various points in each chapter. Each question of the quiz has an answer and detailed explanation. In one embodiment, a chapter or segment test may follow each chapter or segment of comprehensive presentation. In one embodiment, the material set forth in the comprehensive presentation may be cross-referenced and correlated with at least one interactive poster. The poster serves as a quick reference for the student upon completion of the comprehensive presentation.

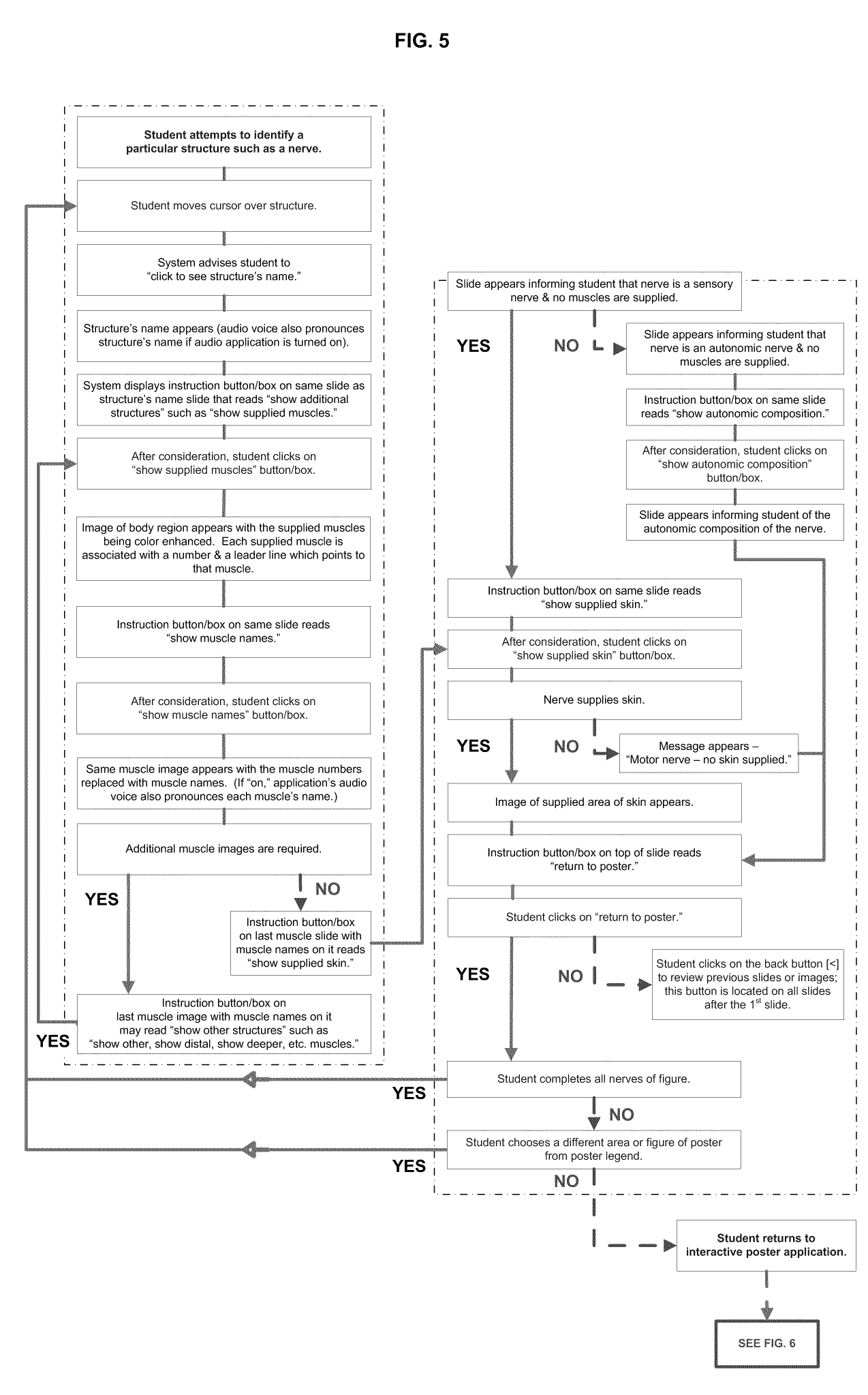

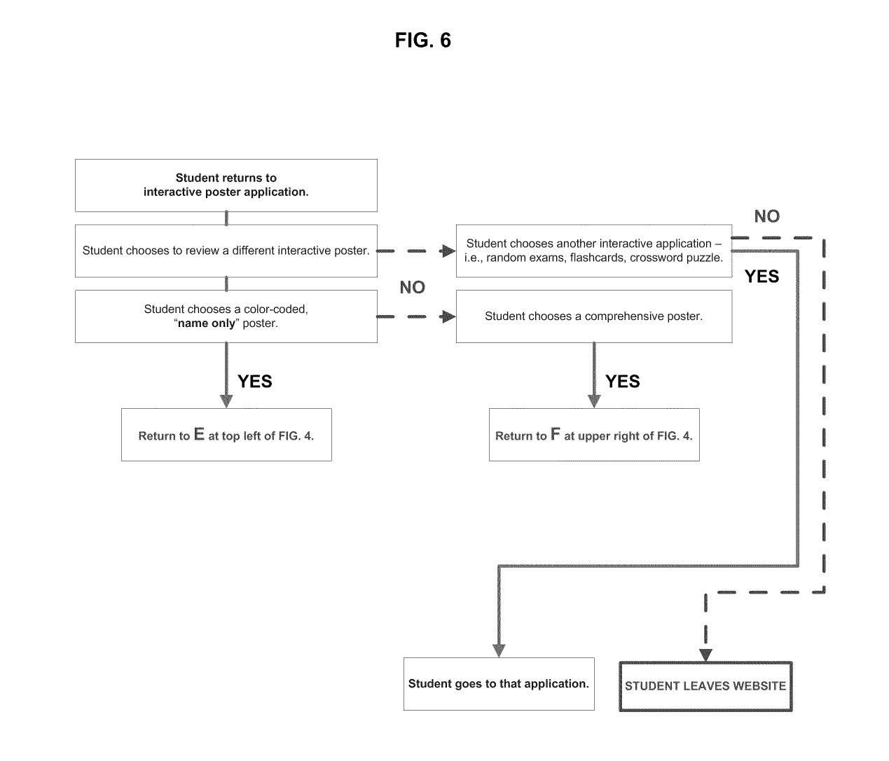

Referring to FIGS. 2-6, upon completion of at least one comprehensive presentation, a student or remote user using a client browser application located at a user work station may access a web access module for an interactive website and may register for use of or log into the site. Once the student is registered or logged in, the student has access to a plurality of interactive educational applications maintained by an educational interactive applications generator module including but not limited to comprehensive examination, random examinations, crossword puzzles, interactive posters and flashcards. The web based interactive educational applications offer continual testing and/or consistent feedback of the information presented in the at least one comprehensive presentation. If the student does not register for use of or log into the site, the student leaves the website (see FIG. 2). In one embodiment, at least one comprehensive presentation may be presented and completed via the interactive website. In this embodiment, student may access the interactive website via the web access module after registering to use the website prior to viewing the presentation of at least one comprehensive presentation and/or participation with a plurality of interactive educational applications.

Student or remote user may observe (or study) the material presented in at least one comprehensive presentation by accessing and registering for use of the interactive website in order to participate in a plurality of interactive educational applications presented by educational interactive applications generator module. Such plurality of interactive educational applications include comprehensive examinations, random examinations, crossword puzzles, interactive posters and flashcards. Student may go to website home page and access one of such interactive educational applications or leave the website. If student leaves the website, student may return to the website at a later time and access one of the other interactive educational applications by entering his or her password received upon registration.

For example, referring now to FIG. 2, in one embodiment, after the observation of at least one presentation, student may access the interactive website and complete a final comprehensive examination. The final comprehensive examination tests the student on multiple categories presented in at least one comprehensive presentation. In one embodiment, the test contains a plurality of questions and is a timed examination. Any number of questions may be used to format a comprehensive examination as desired by one of skill in the art. In one embodiment, comprehensive examination has approximately 180 questions. In one embodiment, comprehensive examination is two timed examinations (for example, two ninety minute examinations). After completing the comprehensive final examination, the system grades or scores the student's performance on examination. Incorrectly answered questions are revealed to student with correct answers and explanations. The system can provide an explanation to any question. Each question in the examination is categorized to a particular category or region of the subject matter presented in at least one comprehensive presentation. The score is broken down to particular categories which allows student to know how he or she performed in different categories of the subject matter and allows the student to improve in those categories of unsatisfactory performance. The system reports to the student the total percentage correct for the entire examination as well as percentage correct for each category or region of the examination. An example of categories is as follows: if nerve anatomy is the subject matter of the comprehensive examination, the categories may include among others autonomic nerves, nerves of neck, nerves of the upper extremity, and cranial nerves. Student receives a percentage correct for each category. Incorrect answers as well as explanations are displayed.

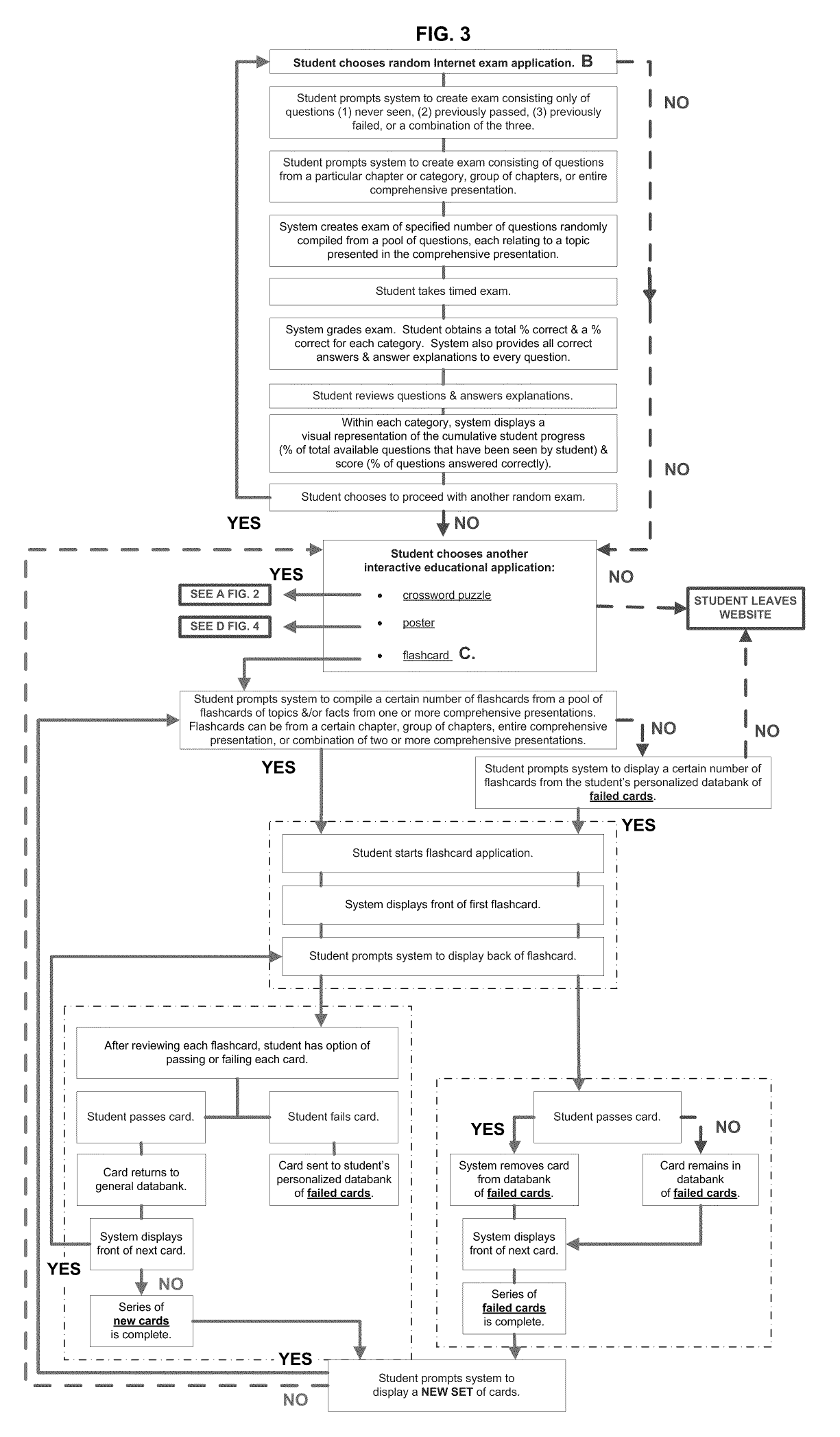

Referring to FIG. 3, after or prior to completing the comprehensive examination, student may choose any other interactive educational application such as the random examination application. The random examination application allows the student or remote user to access and complete random examinations that are randomly compiled from a databank of thousands of questions. Each question is categorized to a specific chapter or category of a comprehensive presentation. If student chooses to create and complete a random internet examination, student prompts system to create an examination consisting of a plurality of questions (such as 20, 40 or 60 board type questions) from a particular chapter or category, from a group of chapters or categories, from the entire comprehensive presentation, or from a group of chapters or categories from different comprehensive presentations. Out of the total number of questions that are available for each chapter or category, system displays a visual representation of the percentage of questions that have previously been answered by the student. In one embodiment, the percentage is displayed as a progress bar. Out of the questions that have previously been answered by the student, system also displays a visual representation of the percentage of questions that were answered correctly. In one embodiment, the percentage may be displayed in a score bar. Student may also direct the system to compile a random examination based on the following question subgroups: only those questions which have never been seen before, only those questions which have been passed before, only those questions which have been failed before, or a combination of all question subgroups. The system creates an examination of a specified number of questions randomly compiled from a databank of questions (for example, thousands of questions), each relating to material presented in at least one comprehensive presentation. Student takes timed examination. System grades the examination, and student obtains a total percentage correct and a percentage correct from each category of the comprehensive presentation. System provides correct answers and explanations to every question. Student may review answers and explanations. At this point, student has the option to create and complete another random internet examination, to access and complete another interactive educational application or to leave the website.

Referring now to FIG. 2, student may use the crossword puzzle educational application to access crossword puzzles. The crossword puzzles may be periodically replaced on the website. The system and method compiles a puzzle from a databank of many (for example, thousands) crossword clues. All clues are based on facts presented in at least one comprehensive presentation. Student directs system to compile a puzzle from crossword clues specific to a particular comprehensive presentation or from a certain combination of comprehensive presentations. Student may download and print puzzle and clues. If the student downloads and prints the puzzle and clues, he or she may work the puzzle during the course of one or more days. Student may return to the website and prompt the system for explanations of particular crossword clues and associated words. The system provides explanations for any crossword clue and associated word requested. Each explanation consists of one or more sentences which briefly explain the answer to the crossword clue. Student may also prompt the system for correctly answered puzzle, and the system will provide the correctly answered crossword puzzle. The crossword puzzles are randomly formulated from a databank of a plurality of individual words which appear in the text of at least one comprehensive presentation. Each word is paired with a clue and an explanation. New puzzles may be created by the system as directed by the student. Once student is provided with the correctly answered crossword puzzle, the student may prompt the system to create a new crossword puzzle for student to work, or student may return to the website home site and has the option to continue learning via other interactive website applications or to leave the website.

In another embodiment, the system and method allows student to work crossword puzzle via the website on a computer instead of downloading and printing the crossword puzzle. Student may prompt system for explanations to unknown crossword clues and associated words. At the request of student, system provides explanation to any crossword clue and associated word. Student may prompt system for correctly answered puzzle. System will provide correctly answered crossword puzzle. Once student is provided with the correctly answered crossword puzzle, student may prompt the system to create a new crossword puzzle to work, or student may return to the website home site and has the option to continue learning via the interactive website applications or to leave the website.

Referring now to FIG. 3, student may access and participate in another interactive educational application such as flashcards. In the flashcard application, student prompts system to compile a plurality of flashcards from a databank of flashcards which cover facts and material presented to the student in at least one comprehensive presentation. Student directs system to compile flashcards that present subject matter from a certain chapter (or category) or chapters (or categories) of at least one comprehensive presentation or from the entire embodiment of at least one comprehensive presentation. Student directs system as to the number of flashcards to present. Student may also direct system to compile flashcards from the following subgroups: only those flashcards which student has never seen before, only those flashcards which student has passed before, only those flashcards which student has failed before, or a combination of all flashcard subgroups. Once the flashcards have been compiled, student starts the flashcard application. The system displays front of a first flashcard. The front of the flashcard may present a question (not necessarily in question format) such as “muscles supplied by a particular nerve” or “branches of a particular nerve.” After consideration, student prompts system to display back of card which displays the corresponding answer in any form such as word or image. After reviewing the flashcard, student has the option of passing or failing the flashcard. If student passes first flashcard, flashcard returns to a general databank and the system displays the front of a second flashcard. If student fails any flashcard, flashcard is sent to student's personalized databank of failed cards and the system displays the front of the second flashcard. This process continues until student has completed the plurality of flashcards initially compiled upon beginning flashcard interactive educational application. Once student has completed the plurality of flashcards, student has the option to prompt system to display the same series of flashcards showing the back of each card first, to prompt system to display a new series of flashcards, to prompt system to display a certain number of flashcards from student's personalized databank of failed flashcards, to choose another interactive educational application or to leave the website.

Alternatively, at the onset of viewing a particular set of flashcards, student has the option of viewing the particular set of flashcards with each card initially displayed with the back of the card appearing. After consideration, the student may prompt the system to display the front of card. Student may pass or fail any flashcard. At the conclusion of viewing the particular set of cards, student has the option of viewing the same set with the front of each card displayed first, to prompt system to display a new series of flashcards, to prompt system to display a certain number of flashcards from student's personalized databank of failed flashcards, to choose another interactive educational application or to leave the website.

Student may access personalized databank of failed flashcards at any time. If student prompts system to display a certain number of flashcards from student's personalized databank of failed flashcards, system displays front of first flashcard. Student prompts system to display back of first flashcard. If student passes first flashcard, system removes flashcard from databank of failed flashcards and displays front of second flashcard until series of failed flashcards is complete. Alternatively, student may prompt system to initially display the back of each flashcard when viewing a particular set of flashcards from the personalized databank of failed flashcards. After consideration, the student may prompt the system to display the front of card. If student passes first flashcard, system removes flashcard from databank of failed flashcards and displays back of second flashcard until series of failed flashcards is complete. At the conclusion of viewing the particular set of cards, student has the option of viewing the same set with the front of each card displayed first, to prompt system to display a new series of flashcards, to choose another interactive educational application or to leave the website. If student fails any of the failed flashcards, the card remains in the databank of failed flashcards.

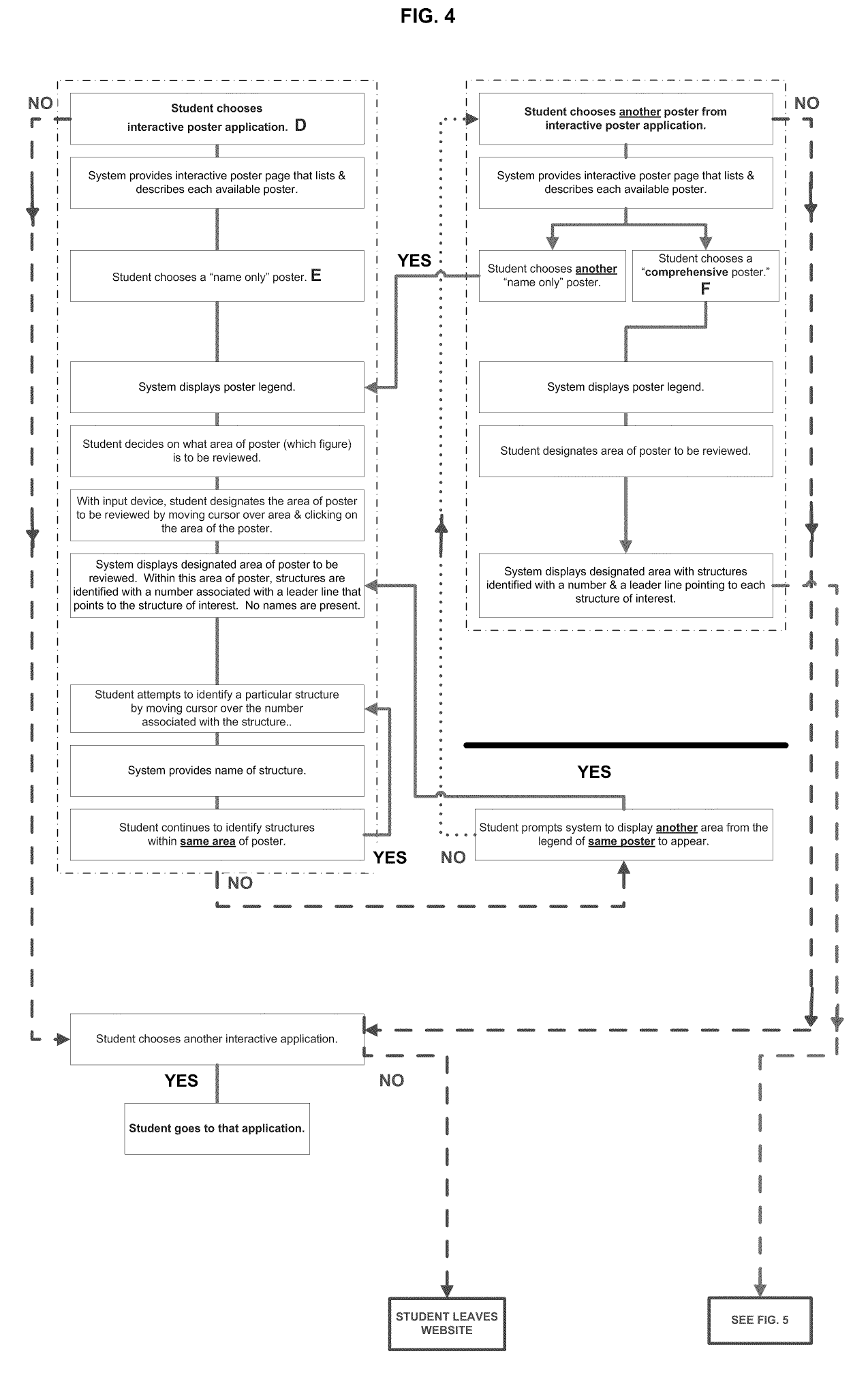

Referring now to FIGS. 4 to 6, student may access and complete another interactive educational application such as interactive posters. Interactive posters correspond and teach the factual material or information presented in at least one comprehensive presentation. In one embodiment, interactive poster teaches anatomic structures such as nerves. System provides interactive poster page which lists and describes each available poster. Student chooses a name-only poster or a comprehensive poster. Both types of posters may user visual indicia to teach such factual material in the comprehensive presentation, such as the posters may be color-coded. A color-coded poster utilizes different colors to represent material presented in at least one comprehensive presentation. The use of different colors facilitates learning. System displays poster legend of name-only poster chosen. The poster legend divides the subject matter of the poster into regions. Student decides which region of the poster to review, and with an input device, for example, a computer mouse or computer keyboard, student designates such region by clicking on that region of the poster. System displays designated region of poster to be reviewed. Within such region of poster, structures may be identified with a number associated with a leader line that points to a structure of interest. Names of structures are not present. Student attempts to identify a particular structure. Student moves cursor over the number associated with a particular structure. System visually provides name of structure. Student may attempt to verify a particular structure without turning on poster audio application, or student may first turn on poster audio application. Poster audio application utilizes an audio voice to correctly pronounce the name of the structure such as a nerve as it appears on the computer screen. Student may continue to identify structures within same area of poster by moving the cursor over the number associated with the structure and allowing the system to provide the name of the structure. At any time, student may prompt the system to display a second region of the poster from the poster legend. Structures of this second region are identified with number associated with a leader line that points to the structure of interest. Student attempts to identify a particular structure and then moves the cursor over the number associated with the structure of interest, at which time the system will provide the name of the structure.

Student may continue learning the various regions of a first poster chosen until student is ready to return to interactive poster page and choose another interactive poster, to choose another interactive educational application or to leave the website. If student returns to interactive poster page to choose another interactive poster, student may choose another name-only poster or a comprehensive poster. If student chooses another name-only poster, the system will display a poster legend and the system and method will proceed as described above.

Student may choose a comprehensive poster. Comprehensive poster may teach any subject matter. In one embodiment, comprehensive poster teaches nerve names and structures supplied. Such comprehensive poster will be used as an example. System provides legend of poster. The poster legend divides the subject matter of the poster into regions. Student designates region of poster to review. System displays designated region of structures such as nerves identified by a number and a leader line pointing to each structure. Student may attempt to verify a particular nerve without turning on poster audio application, or student may first turn on poster audio application. Poster audio application utilizes an audio voice to correctly pronounce the name of the structure such as a nerve or muscle as it appears on the computer screen.

To verify a particular structure, student moves cursor over its particular number. System advises student to click on such number to verify the name of such structure. If student clicks on the number, the slide indicating the name appears. If audio application is on, audio voice pronounces name of structure. System displays instruction box on same slide that allows system to show any supplied muscles of a particular structure, for example, a nerve. After consideration, student may choose to view supplied muscles and will click on instruction box. If the nerve supplies muscles, an image of a body region appears with supplied muscles. Such image may be color enhanced. Each supplied muscle is associated with a number and a leader line which points to the muscle. Instruction box on same slide allows system to show muscle names. After consideration, student clicks on the instruction box to view muscle names. Same muscle image appears with the muscle numbers replaced with muscle names. If on, audio voice of audio application pronounces name of each muscle. If additional muscle images are applicable, instruction box on muscle image displaying muscle names will appear and allows system to show additional muscle images such as deeper or distal muscles. Image of body region appears with supplied muscles color enhanced. Each supplied muscle is associated with a number and a leader line which points to the muscle. Instruction box on same slide allows system to show muscle names. After consideration, student chooses to view muscle name and will click on the instruction box. Same muscle image appears with the muscle numbers replaced with muscle names. If on, audio voice of audio application pronounces name of each muscle.

If muscle images displaying additional muscles (such as deeper or distal muscles) are not applicable, instruction box on muscle slide displaying muscle names allows system to show supplied skin. After consideration, student instructs system to show supplied skin and if the nerve supplies skin, an image of supplied skin for a particular nerve appears. If the nerve is a motor nerve and does not supply skin, student will be advised that no skin is supplied. Once image of supplied skin is displayed or once student is advised that no skin is supplied or at anytime earlier, student has the option to go back and review previously viewed slides, to return to poster and complete all nerves of a particular region of the poster, choose another region of the poster from poster legend, or return to interactive poster page. If student returns to interactive poster page, student may choose to review a different interactive poster, choose another interactive educational application or leave the website.

If a nerve does not supply muscles, slide appears that informs student that nerve is a sensory nerve or an autonomic nerve and that no muscles are supplied. If slide indicates nerve is a sensory nerve, instruction box on same slide allows the system to show supplied skin. After consideration, student may instruct the system to show supplied skin. An image of supplied area of skin appears. If slide indicates nerve is an autonomic nerve, system will allow student to show autonomic composition. After consideration, student may choose to show autonomic composition and may click on the instruction box. Slide appears informing student of the autonomic composition of the nerve. Once the autonomic composition of the nerve has been displayed or the supplied skin has been displayed, student has the option to go back and review previously viewed slides, return to poster and complete all nerves of a particular region of the poster, choose another region of the poster from poster legend, or return to interactive poster page. If student returns to interactive poster page, student may choose to review a different interactive poster, choose another interactive educational application or leave the website.

Other interactive posters may present, teach and reinforce factual information. This information may be unique and associated with other comprehensive presentations or several posters may be associated with the same comprehensive presentation. Multiple comprehensive presentations may exist. In one embodiment, the skeleton interactive posters consist of a name-only and comprehensive poster. Each poster is associated with a poster legend and is navigated by the student in the same mechanism as described above. The name-only version has leader lines which point to bones or bone surface anatomy details. At the opposite end of the leader line is either a red or black dot. No names are present. A red dot indicates that the name of the bone is required. A black dot indicates that the name of a surface anatomy detail is required. Examples of such details may include but are not limited to various heads, necks, shafts, notches, lines, tubercles, tuberosities, protuberances, sutures, and foramina. When the student moves the cursor over a red dot, the name of the bone visually appears. When the cursor is moved over a black dot, the name of the surface anatomy detail visually appears. If on, audio voice of audio application pronounces name of each bone or bone detail.

In the comprehensive version of the skeleton interactive poster, bones are identified with a number associated with a leader line that points to a bone of interest. Names of bones are not present. Student attempts to identify a particular bone. Student moves cursor over the number associated with a particular bone. System visually advises student to click on such number to verify bone name. If student clicks on the bone number, the slide indicating bone name appears. If audio application is on, audio voice pronounces bone name. System displays instruction box on same slide that allows system to show image of details of surface anatomy for that particular bone. After consideration, student may choose to view surface anatomy details and will click on instruction box. An image of the bone appears with surface anatomy details identified by a number and a leader line which points to the detail. No anatomic names are present. Instruction box on same slide allows system to show surface detail names. After consideration, student may choose to view names and will click on instruction box. The same bone image appears with the numbers replaced with the names of the surface anatomy details. If on, audio voice of audio application pronounces name of each bone detail. Instruction box on same slide allows system to show image of muscle origins and insertions. After consideration, student may choose to view origins and insertions and will click on the instruction box. An image of that particular bone appears with the areas of the bone which serve as the origin of a muscle colored in red and the areas of the bone which serve as the insertion of a muscle colored in green. To teach the student that the origin is a muscle's fixed place of attachment and its insertion is the attachment to the bone or other structure it moves upon contraction, the bone areas are colored in this way. A legend in the bottom right of this slide displays that red (stop) equals origin and green (go) equals insertion. Other colors or forms of identification may be used as desired by one of skill in the art. Each colored area of bone is associated with a number and a leader line that points to the colored area. Instruction box on same slide allows system to show muscle names. After consideration, student may choose to view names and will click on instruction box. The same bone image appears with the numbers replaced with the names of the muscles that originate or insert on each of the colored areas. If on, audio voice of audio application pronounces name of muscle. If required, instruction box on same slide allows system to show image of different views of same bone. After consideration, student may choose to view other views of same bone and will click on instruction box. The process will continue in the same sequence of slides and instruction boxes as that which is described above. If additional views of same bone are not required or student has completed sequence of slides and instruction boxes associated with additional views, student may go back and view previously viewed slides, return to the poster and identify a different bone in the same area of the comprehensive skeleton poster, move to a different region of the same poster, or return to the interactive poster page or leave the website. If student returns to interactive poster page, student may choose to review a different interactive poster, choose another interactive educational application or leave the website.

In another embodiment, the interactive poster is a cranial nerve poster. An image of each of the twelve cranial nerves is positioned in a circumferential fashion around the periphery of the poster. Each cranial nerve image is located at the position of a clock that correlates with the cranial nerve number of that particular nerve. For example, the oculomotor nerve, cranial nerve III (CN III), is located at the 3 o'clock position or right central area of the poster. In the center of the poster is an image of the brain that depicts all twelve pair of the cranial nerves originating from the brain and the anatomic relationships that exist among the different cranial nerves. The cranial nerve poster consists of a name-only and comprehensive version. Each is associated with a poster legend and is navigated by the student in the same mechanism as described above. Other than the difference in the organizational layout and anatomic structures that are depicted, the navigation and use of the name-only version is similar to that which is described for the name-only version described above.

The comprehensive version of the cranial nerve interactive poster is similar to the comprehensive version of the interactive version described above where structures such as nerves are identified with a number associated with a leader line that points to a structure (nerve) of interest. In the cranial nerve interactive poster, names of structures or nerves are not present. Student attempts to identify a particular nerve. Student moves cursor over the number associated with a particular nerve. System visually advises student to click on such number to verify nerve name. If student clicks on the nerve number, the slide indicating nerve name appears. If audio application is on, audio voice pronounces nerve name. System displays instruction box on same slide that allows system to show the types of nerve fibers that are contained in that particular nerve. After consideration, student may choose to view nerve fiber composition and will click on instruction box. A slide appears which depicts from one to five fiber types that travel within a particular nerve. Many nerves carry only one fiber type. The most carried by any one nerve is five fiber types. The types of fibers that may be listed include special sensory afferent, special somatic afferent, special visceral afferent, general visceral afferent, general somatic afferent, special visceral efferent, general visceral efferent, and general somatic efferent fibers. Instruction boxes on same slide allow system to show what information is transmitted by each fiber type. Each fiber type listed on slide is associated with its own instruction box that allows student to view the information which is transmitted by that particular fiber type of that particular nerve. For example, a nerve that is composed of three different fiber types will have three instruction boxes on this slide, one for each fiber type. After consideration, student may choose to view what information is transmitted by a particular fiber type of a particular nerve and will click on one instruction box. A slide appears which reveals the information that is transmitted by that fiber type of that nerve. For example, the information could be sensation from mucous membranes of the lower mouth or innervation of muscles derived from myotomes. If additional factual material exists, instruction box on same slide allows system to show what information is to be displayed. After consideration, student may choose to view factual material. This sequence continues until all slides concerning a particular fiber type of a particular nerve have been viewed. Within the last slide of a sequence of slides specific for a particular fiber type of a particular nerve is an instruction box that allows student to return to the slide which lists all fiber types carried by the particular nerve if the particular nerve carries more than one fiber type. Upon returning to list of fiber types carried by particular nerve, student, after consideration, may choose to view information that is carried by a different fiber type of same particular nerve. This process continues until all slides concerning information carried by all fiber types of a particular nerve have been viewed or student leaves slide sequence to view information carried by another nerve, go to a different region of the same poster, go to a different interactive poster, participate in a different interactive educational application or leave the website. Upon viewing information carried by all fiber types of a particular nerve, student may return to cranial nerve comprehensive poster and proceed with a different nerve of the same region, go to a different region of same poster, or go to interactive poster page. If student goes to poster page, student may view a different interactive poster, participate in a different interactive educational application, or leave the website. In instances in which the particular nerve carries only one fiber type, the last slide of a sequence of slides specific for the fiber type of the particular nerve contains an instruction box that allows student to return to cranial nerve comprehensive poster. At that point, the student may proceed with a different nerve of the same region, go to a different region of same poster, or go to interactive poster page. If student goes to poster page, student may view a different interactive poster, participate in a different interactive educational application, or leave the website.

In instances in which muscles are supplied by a particular fiber type of a particular nerve, system displays a slide that visually informs student that the particular fiber type supplies one of two general classifications of muscles: muscles derived from myotomes or muscles derived from branchial arches. System displays instruction box on same slide that allows system to show image of supplied muscles of a particular fiber type of a particular nerve. After consideration, student may choose to view supplied muscles and will click on instruction box. An image of a body region appears with supplied muscles color enhanced. Each supplied muscle is associated with a number and a leader line which points to the muscle. Instruction box on same slide allows system to show muscle names. After consideration, student clicks on the instruction box to view muscle names. Same muscle image appears with the muscle numbers replaced with muscle names. If on, audio voice of audio application pronounces name of each muscle. If additional muscle images are applicable, instruction box on muscle image displaying muscle names will appear and allows system to show additional muscle images such as deeper or distal muscles. Image of body region appears with supplied muscles color enhanced. Each supplied muscle is associated with a number and a leader line which points to the muscle. Instruction box on same slide allows system to show muscle names. After consideration, student chooses to view muscle name and will click on the instruction box. Same muscle image appears with the muscle numbers replaced with muscle names. If on, audio voice of audio application pronounces name of each muscle.

If muscle images displaying additional muscles (such as deeper or distal muscles) are not applicable, instruction box on muscle slide displaying muscle names allows student to return to the slide which lists the different types of fibers the particular nerve carries if particular nerve carries more than one fiber type or return to comprehensive cranial nerve poster if particular nerve is composed of only one fiber type.

The application of the system and method for interactive learning in the teaching of nerve anatomy has been described. The system may be applied to other courses including cranial nerve anatomy, pathology and medical language course. Like the nerve anatomy course, information from each course is initially presented to student in a comprehensive presentation. If previously registered on website, upon completion of comprehensive presentation student may access same website as utilized for nerve anatomy course and engage in interactive applications as described above to reinforce the information learned in the comprehensive presentation. If not registered, student may go to website and register. Interactive educational applications such as comprehensive examinations, random examinations, interactive posters, crossword puzzles and flashcards may be created by the system as directed by student. In one embodiment, student may direct the system to compile a crossword puzzle created by factual information contained only in the nerve anatomy course, cranial nerve anatomy course, pathology course, medical language course, or any combination of the four courses (which each represent a comprehensive presentation). Flashcards and random examinations may be compiled from any combination of chapters or categories from any combination of the four courses as directed by the student. These four courses or comprehensive presentations, nerve anatomy, cranial nerve anatomy, pathology, medical language, are presented as examples that currently exist. The system will utilize a plurality of comprehensive presentation.

The system and method for interactive learning has widespread potential application. The system and method for interactive learning is capable of teaching and reinforcing one or more comprehensive presentations. In one embodiment, for exemplary purposes only, the system and method is used to teach anatomy in particular the peripheral nervous system to prospective medical students. The peripheral nervous system is the focus used to teach human anatomy. Anatomy is typically taught by regions or compartments. The student learns all structures in a certain region, such as the arm. When the study progresses to another region, such as the forearm, the student may have difficulty relating the structures of the two regions. In order to teach nerve anatomy, basic anatomy and physiology are first taught. Basic anatomy and physiology includes anatomic positions, directions, terminology, and regions of the body. The skeleton, body cavities and circulatory system are also described. As the student progresses through the peripheral nerves by using the disclosed system and method, the location of the peripheral nerves in relation to other structures is described. By consistent feedback and continual testing, the student not only learns every named peripheral nerve of the body, but also every bone and muscle. Numerous other anatomic structures, such as the heart and great vessels, are also covered. All anatomic structures are learned based on their relationship to various peripheral nerves.

Included in the widespread potential of system is the broad and uniform application of system and method for interactive learning to a particular group of books, courses, schools, companies, and organizations. For example, a particular publisher may furnish a website and provide a plurality of web-based interactive applications as described above for each textbook it publishes. Student may decide from which textbooks or chapters of textbooks to compile information for the various interactive applications. Such a system would add significant value to any future textbook published by publisher and would give publisher a competitive advantage over textbooks published by other publishers which did not provide such a system for their textbooks. Another example is a particular school which may provide such a system for their students which includes information contained in each of the courses taught at the school. As a student enrolls in or has completed a particular course, the student could prompt system to compile random exams, crossword puzzles, or flashcards from that course. If utilized regularly, grades and standardized test scores would improve. Student decides from which textbooks or from which courses the interactive applications are directed. Not only does this provide an efficient and effective means to learn, but continued review of the material as contained within the interactive applications creates an excellent mechanism to maintain a significant knowledge base.

System may provide a feedback mechanism which provides information about the user. Messages such as electronic messages may be periodically sent by system to users, parents, bosses, teachers, coaches or any individual deemed appropriate by individual or organization providing system to user. Included in feedback information could be the amount of time spent on website and proportion spent on each of the various interactive applications. Information from random examinations may provide information on how well student is doing on questions from each of the various sub groupings of information. This information can be correlated with users past performance. For example, a graft may depict the percentage of questions specific to the autonomic nervous system which were answered correctly by user on a week to week basis over the last six months. This information, including time on site, utilization percentage of different interactive applications, and percentage of correctly answered questions from each of the question sub groupings contained in random exam databank, could also be correlated with peers of user. Peer groupings could be based on individuals taking a particular course, individuals reading a particular textbook, education level, age, employment, or some other grouping. Feedback is intended to identify areas in which future work should be focused and a mechanism to improve the effectiveness of learning.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the disclosed invention and equivalents thereof.

I claim:

1. A system for interactive learning that allows a student or a remote user to learn a substantial body of information without, or as a compliment to, formal instruction, classes or courses, comprising:
a. at least one comprehensive presentation comprising a substantial body of information, wherein the presentation has a network of continual testing throughout the presentation;
b. a web access module for an interactive website configured to allow a remote user using a client browser application located at a user work station to access the system over the Internet; and
c. an educational interactive applications generator module configured to present a plurality of web based interactive educational applications, wherein the interactive educational applications offer continual testing and/or consistent feedback of the information presented in the at least one comprehensive presentation.

2. The system of claim 1 wherein the comprehensive presentation presents the information in one or more of the formats selected from the group consisting of a lecture series, book, audio recording, video tape, and internet presentation.

3. The system of claim 1 wherein the information presented in the comprehensive presentation may be cross-referenced with at least one interactive poster.

4. The system of claim 1 wherein the plurality of web based interactive educational applications comprise comprehensive examinations, random examinations, crossword puzzles, flashcards, and/or interactive posters.

5. The system of claim 4 wherein the comprehensive examination has a plurality of questions, wherein each question is assigned to a particular category of the information presented in the comprehensive presentation.

6. The system of claim 5 wherein the system reports to the student the score of the comprehensive examination according to particular categories as well as the total percentage correct for the entire comprehensive examination.

7. The system of claim 4 wherein the random examinations application comprise examinations with a specified number of questions from a particular category of the comprehensive presentation, group of categories of the comprehensive presentation or entire comprehensive presentation, wherein the questions are randomly compiled from a pool of questions, each relating to a topic presented in the comprehensive presentation.

8. The system of claim 4 wherein the random examinations applications comprise examinations with a specified number of questions, wherein the questions are selected from the group consisting of questions which have never been seen before, questions which have been passed before, questions which have been failed before and a combination of all question groups, wherein the questions are randomly compiled from a pool of questions, each relating to a topic presented in the comprehensive presentation.

9. The system of claim 4 wherein the random examinations applications includes a visual representation of the percentage of total available questions that have been seen by user and percentage of questions answered correctly by user.

10. The system of claim 4 wherein the crossword puzzle application includes puzzles that are randomly formulated from a databank of a plurality of individual words which appear in the text of at least one comprehensive presentation.

11. The system of claim 4 wherein the interactive poster application includes visual indicia and audio application to teach the factual information presented in at least one comprehensive presentation.

12. A web based interactive learning system for a student or remote user to learn a substantial body of information over the Internet without, or as a compliment to, formal instruction, classes or courses, the user using a client browser application located at a user work station for communicating with an interactive learning system, the system comprising a web access module for interactive website configured to allow the remote user to access at least one comprehensive presentation and a plurality of web based interactive educational applications, wherein the interactive educational applications offer continual testing and/or consistent feedback of the information presented in the at least one comprehensive presentation.

13. A method for interactive learning that allow a student and/or a remote user to learn a substantial body of information, compiled into a comprehensive presentation, without, or as a compliment to formal instruction, classes or courses, the user using a client browser application located at a user work station, the method comprising:
a. observing at least part of at least one comprehensive presentation comprising a substantial body of information, wherein the presentation has a network of continual testing throughout the presentation;
b. accessing a web based module for an interactive website configured to allow a remote user to access the system over the Internet, wherein the system includes an educational interactive applications generator module configured to present a plurality of web based interactive educational applications, wherein the interactive educational applications offer continual testing and consistent feedback of the information presented in the at least one comprehensive presentation;
c. registering for or logging into the interactive website;
d. participating in at least one educational application via the educational interactive applications generator module; and
e. leaving the interactive website.

14. The method of claim 13 wherein the comprehensive presentation presents the information in one or more of the formats selected from the group consisting of a lecture series, book, audio recording, video tape, and internet presentation.

15. The method of claim 13 wherein the plurality of web based educational applications may be one or more applications selected from the group consisting of a comprehensive examination, random examinations, crossword puzzles, flashcards and interactive posters.

16. A method for interactive learning that allows a student or remote user to learn a substantial body of information, compiled into at least one comprehensive presentation, without, or as a compliment to formal instruction, classes or courses, comprising:
a. accessing a web based module for an interactive website configured to allow a remote user to access the system over the Internet, wherein the system is configured to present at least one comprehensive presentation comprising a substantial body of information, wherein the system includes an educational interactive applications generator module configured to present a plurality of web based interactive educational applications, wherein the interactive educational applications offer continual testing and consistent feedback of the information presented in the at least one comprehensive presentation;
b. registering for or logging into the interactive website;
c. observing at least part of at least one comprehensive presentation;
d. participating in at least one educational application via the educational interactive applications generator module; and
e. leaving the interactive website.

17. The system of claim 1 wherein the system has a feedback mechanism.
